(19) United States
(12) Patent Application Publication
(10) Pub. No.: US 2017/0335798 A1
(43) Pub. Date: Nov. 23, 2017

(54) IGNITION METHOD FOR LIQUID PROPELLANT ENGINE

(71) Applicant: SNECMA, Paris (FR)

(72) Inventor: Valentin HUE, Vernon (FR)

(73) Assignee: AIRBUS SAFRAN LAUNCHERS SAS, Paris (FR)

(21) Appl. No.: 15/520,739

(22) PCT Filed: Oct. 19, 2015
(86) PCT No.: PCT/FR2015/052793

§ 371 Date: Apr. 20, 2017

(30) Foreign Application Priority Data
Oct. 21, 2014 (FR) 1460126

(51) Int. Cl. F02K 9/62; F02K 9/95; F02K 9/50; F02K 9/58; F02K 9/52

(52) U.S. Cl. CPC F02K 9/62; F02K 9/95; F02K 9/50; F02K 9/52; F02K 9/58

(57) ABSTRACT

A method of starting combustion of a space vehicle engine, the method comprising igniting a propellant tank heater (25); once the heater (25) has reached stable conditions, pressurizing a first tank (23) containing the first propellant and a second tank (24) containing a second propellant, and in parallel filling respectively a first igniter tank (13) with the first propellant in gaseous form and a second igniter tank (14) with the second propellant in gaseous form until ignition thresholds values of temperature (T₁₃, T₁₄) and of pressure (P₁₃, P₁₄) have been reached; and injecting the first and second propellants in gaseous form contained in the first and second igniter tanks (13 and 14) into an igniter (12) of the engine, so as to initiate combustion.

### GENERAL TECHNICAL FIELD

The present invention relates to the field of igniters for initiating combustion in the combustion chambers of space vehicle engines.

### STATE OF THE ART

Combustion chambers that do not make use of self-igniting propellant pairs require an igniter to be used to initiate combustion. Unfortunately, self-igniting propellants are more difficult to handle than non-self-igniting propellants, and it is therefore always advantageous to make use of propellants that are not self-igniting in association with an igniter.

Igniters are thus known that make use of the propellants of the engine cycle to initiate combustion in the combustion chamber. Such igniters thus enable reignitions to be performed, and they do not require specific propellants for ignition purposes.

Nevertheless, such igniters require the propellants to arrive in the igniter in gaseous form in order to ensure that combustion is stable, and they require this feed of propellants in gaseous form to be reproducible for any reignitions that might take place under conditions (in particular temperature conditions) that can be very variable and difficult to control.

Furthermore, such igniters are coupled with the engine cycle. Specifically, since the propellants injected into the igniter are taken from the propellants used for the engine cycle, the rates at which propellants are injected into the igniter thus depend on the rates at which propellants are injected into the combustion chamber for the engine cycle.

The present invention thus seeks to propose a solution that improves these aspects, at least in part.

### SUMMARY OF THE INVENTION

To this end, the present invention provides a method of starting combustion in a space vehicle engine, the method comprising:
igniting a heater for heating tanks of first and second propellants;
waiting until the heater reaches stable conditions;
pressurizing a first tank containing the first propellant in liquid form up to a first threshold pressure by means of the heater, and in parallel filling a first igniter tank with the first propellant in gaseous form, until reaching first ignition threshold values of temperature and of pressure;
pressurizing a second tank containing the second propellant in liquid form up to a second threshold pressure by means of the heater, and in parallel filling a second igniter tank with the second propellant in gaseous form, until reaching second ignition threshold values of temperature and of pressure; and
injecting the first and second propellants in gaseous form contained in the first and second igniter tanks into an igniter of the engine, so as to initiate combustion.

By way of example, the first propellant is liquid oxygen and the second propellant is liquid hydrogen.

In a particular implementation, after initiating combustion, the space vehicle engine is put into operation.

Typically, the pressurization of the first tank and the pressurization of the second tank are performed in succession or else simultaneously.

The invention also provides a system comprising:
a first tank of liquid propellant and a second tank of liquid propellant;
a space vehicle engine igniter fed with gaseous propellants by a first igniter tank and a second igniter tank;
a heater for pressurizing the first tank of liquid propellant and the second tank of liquid propellant; and
a controller adapted to control the heater so as to pressurize the first and second liquid propellant tanks by the heater under stable conditions;

the system being characterized in that the controller and the heater are configured:
while pressurizing the first liquid propellant tank, to feed the first propellant in gaseous form to the first igniter tank until reaching threshold ignition values of temperature and of pressure;
while pressurizing the second liquid propellant tank, to feed the second propellant in gaseous form to the second igniter tank until reaching threshold ignition values of temperature and of pressure; and
the controller also being configured in such a manner as to inject the contents of the first igniter tank and of the second igniter tank into the space vehicle engine igniter so as to initiate combustion.

By way of example, the first propellant is liquid oxygen and the second propellant is liquid hydrogen.

Typically, the controller is configured to control putting the space vehicle engine into operation after initiation of combustion by injecting the contents of the first igniter tank and of the second igniter tank into the space vehicle engine igniter.

Typically, the controller is configured to control the heater in such a manner that the first igniter tank and the second igniter tank are fed in succession or else simultaneously.

In an example:
the first igniter tank is connected to the igniter via a first igniter valve and to the heater via a first feed valve; and
the second igniter tank is connected to the igniter via a second igniter valve and to the heater via a second feed valve;

the controller being adapted to control the opening and closing of the first and second igniter and feed valves.

The invention also provides a space vehicle including a liquid propellant engine and a system as presented above.

### BRIEF DESCRIPTION OF THE FIGURES

Other characteristics, objects, and advantages of the invention appear from the following description, which is purely illustrative and non-limiting, and which should be read with reference to the accompanying figures, in which:

FIG. 1 is a diagram showing a system in an aspect of the invention;

FIG. 2 is a diagram illustrating a method in an aspect of the invention; and

FIG. 3 is a diagram illustrating a variant of the method illustrated in FIG. 2.

In all of the figures, elements that are in common are identified by numerical references that are identical.

### DETAILED DESCRIPTION

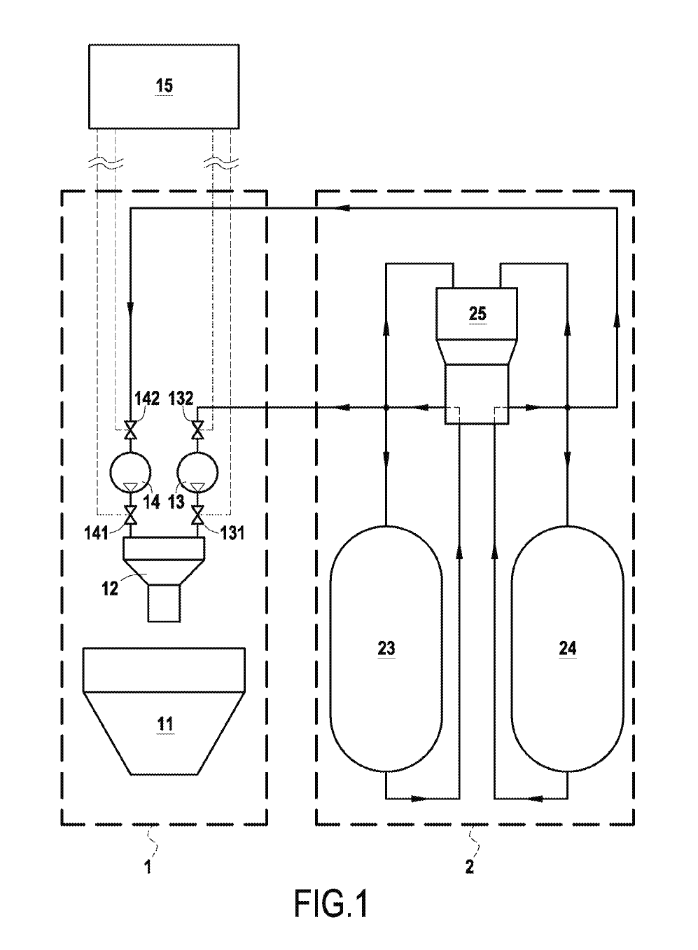

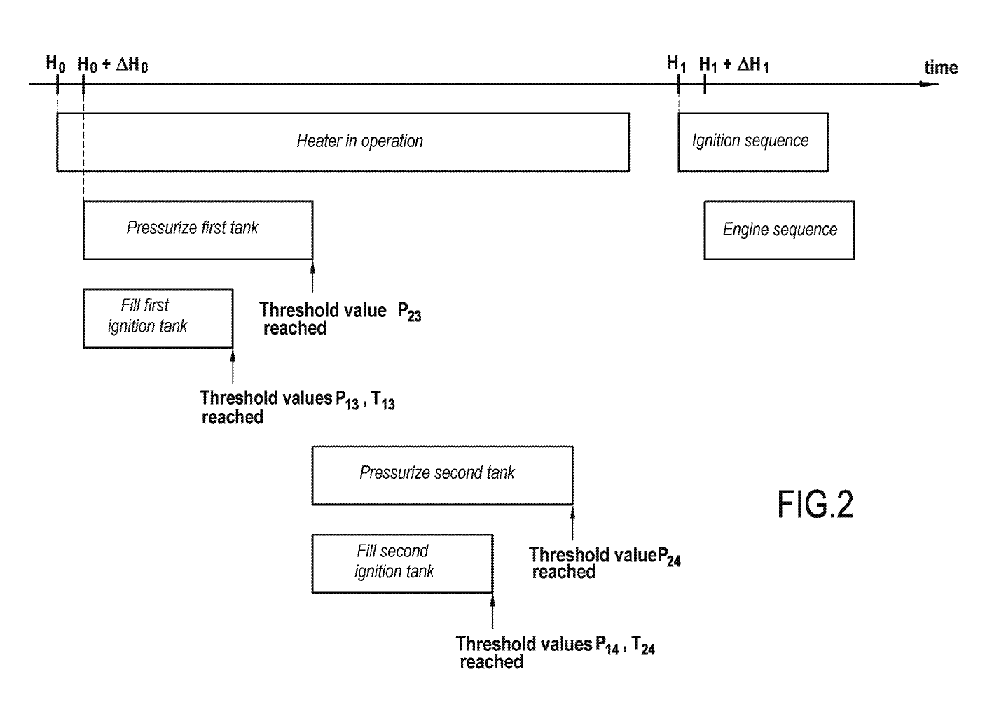

FIG. 1 shows a system in an aspect of the invention, and FIG. 2 illustrates a method of starting combustion in such a system.

The system as shown comprises a combustion device 1 and a storage device 2.

The combustion device 1 has a combustion chamber 11, an igniter 12, a first igniter tank 13, and a second igniter tank 14.

The first igniter tank 13 and the second igniter tank 14 are each connected to the igniter 12 by means of valves, respectively a first igniter valve 131 and a second igniter valve 141, and they are adapted to contain propellants in gaseous form, thereby feeding the igniter 12 with gaseous propellants.

The storage device 2 has a first propellant tank 23 and a second propellant tank 24 that are adapted to contain first and second propellants, respectively.

The storage device also has a heater 25, adapted to put the first and second propellant tanks 23 and 24 under pressure so as to apply a determined pressure therein.

The structure of such a heater 25 is well known and it is therefore not described in detail. In general manner, it involves equipment comprising a heat exchanger for heating propellants such as hydrogen and oxygen, together with an inert gas such as helium that is used for putting the tanks 23 and 24 under pressure.

The system of the invention makes use of the heater 25 by connecting it to the first igniter tank 13 and to the second igniter tank 14 so as to enable them to be filled with gaseous propellants taken from the outlet of the heater 25.

The first igniter tank 13 is thus connected to the heater 25 via a first feed valve 132, while the second igniter tank 14 is connected to the heater 25 via a second feed valve 142.

The system of the invention thus establishes a connection between the igniter 12 and the storage device 2, and it makes use of already-existing elements, namely the heater 25, for filling the first igniter tank 13 and the second igniter tank 14 with propellants that are gaseous.

The system also comprises a controller 15 that is adapted to control the opening and closing of the valves 131, 132, 141, and 142.

An example of how this system operates is described below with reference to FIG. 2.

An initial instant H₀ is defined as being the starting instant of the method.

At this instant H₀, the heater 25 is put into operation.

After a waiting duration ΔH₀, enabling the heater 25 to reach stable operating conditions, and typically of the order of a few seconds, the first tank 23 containing a first propellant in liquid form is pressurized up to a first threshold pressure P₂₃.

In parallel with this pressurizing of the first tank 23, the first igniter tank 13 is filled with the first propellant in gaseous form as taken from the heater 25. The controller 15 thus opens the first feed valve 132 until the temperature and pressure threshold values P₁₃ and T₁₃ are reached in the first igniter tank 13. Once these conditions are reached, the controller 15 closes the first feed valve 132, and the first feed tank 13 thus contains a first propellant in gaseous form under predetermined conditions of temperature T₁₃ and pressure T₁₃.

The igniter tanks 13 and 14 are typically of dimensions that are smaller than the tanks 23 and 24; they are thus typically filled over a duration that is shorter than the duration of pressurizing the tanks 23 and 24. FIG. 2 and its description are based on this assumption. The first igniter tank 13 is advantageously filled while the first tank 23 is being pressurized. The filling of the first igniter tank 13 can begin simultaneously with pressurization of the first tank 23, or in a manner that is slightly offset in time. The filling of the first igniter tank 13 is advantageously performed in such a manner as to be completed before the pressurization of the first tank 23 has been completed.

Once the first tank 23 is under pressure and once the first igniter tank 13 has been filled, the second tank 24 is put under pressure and the second igniter tank 14 is filled.

The second tank 24 containing a second propellant in liquid form is thus pressurized using the heater 25 up to a first threshold pressure P₂₄.

In parallel with this pressurizing of the second tank 24, the second igniter tank 14 is filled with the second propellant in gaseous form as taken from the heater 25. The controller 15 thus opens the second feed valve 142 until threshold temperature and pressure values P₁₄ and T₁₄ are reached in the second igniter tank 14. Once these conditions have been reached, the controller 15 closes the second feed valve 142, and the second igniter tank 14 thus contains a second propellant in gaseous form under predetermined conditions of temperature T₁₄ and pressure T₁₄.

The second igniter tank 14 is advantageously filled while the second tank 24 is being pressurized. The filling of the second igniter tank 14 can begin simultaneously with pressurizing the second tank 24, or in a manner that is slightly offset in time. The filling of the second igniter tank 14 is advantageously performed so as to be completed before the pressurizing of the second tank 24 is completed.

The various pressure and temperature threshold values P₂₃, P₂₄, P₁₃, P₁₄, T₁₃, and T₁₄ are defined, in particular as a function of the natures of the propellants used, and of the characteristics of the ignition 12, or more generally of a space vehicle engine incorporating the system described.

Once the second tank 24 has been put under pressure and the second igniter tank 14 filled, the heater 25 can be stopped.

At an instant H₁, a sequence of igniting combustion is started, during which the gaseous propellants contained in the first igniter tank 13 and the second igniter tank 14 are injected into the igniter 12 in order to initiate combustion.

The injection is typically performed by means of the controller 15 opening the first igniter valve 131 and the second igniter valve 141.

Insofar as the gaseous propellants contained in the first and second igniter tanks 13 and 14 are under predetermined conditions of temperature and pressure, it is possible to initiate combustion in reliable manner.

After a duration ΔH₁ corresponding to the duration of the ignition sequence, and thus to initiating combustion, an engine sequence is engaged corresponding to operation of the engine that includes the system described.

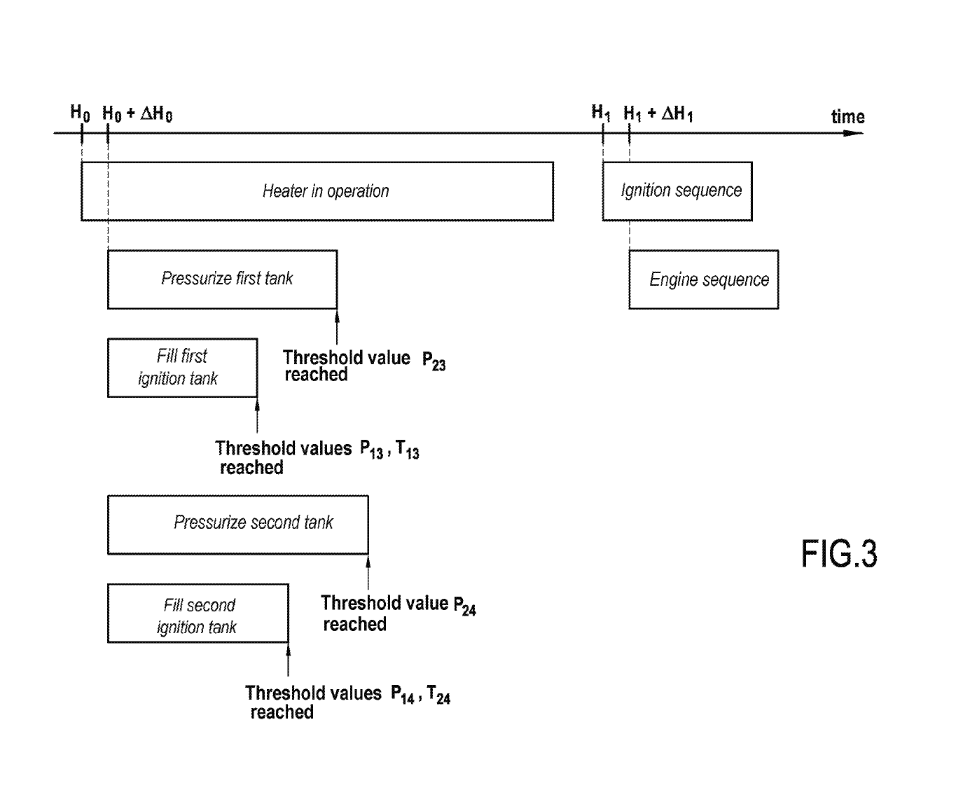

FIG. 3 shows a variant implementation of the method illustrated in FIG. 2, in which the pressurizing of the second tank 24 and the filling of the second igniter tank 14 are performed simultaneously with pressurizing the first tank 23 and filling the first igniter tank 13.

The instant H₁ in this implementation can thus typically be reached sooner than in the above-described implementation.

The times required for filling the igniter tanks 13 and 14 may be different or identical. Likewise, the times required for pressurizing the tanks 23 and 24 may be different or identical.

The filling of the tanks 23 and 24 and the pressurizing of the igniter tanks 13 and 14 can thus be performed successively, simultaneously, or in such a manner as to overlap. The pressurizing of the second tank 24 and the filling of the second igniter tank 14 may for example begin while the pressurizing of the first tank 23 and/or the filling of the first igniter tank 13 have not been completed, or vice versa.

The system and the method as described present several advantageous effects.

Firstly, the filling of the first and second igniter tanks 13 and 14 is performed under controlled conditions, such that the temperature and pressure conditions therein are predefined, thus ensuring that the thermodynamic conditions of the propellants used for ignition are reproducible, thereby making ignition more reliable.

Furthermore, the feeding of propellants to the igniter 12 is decoupled from the operating cycle of the engine, thus making it possible to control the ignition sequence and the engine sequence in quasi-independent manner.

Finally, the system and the method described make use of elements that are already present in a space vehicle engine, and therefore they require very few specific components, which is advantageous in terms of weight and cost.

1. A method of starting combustion in a space vehicle engine, the method comprising:
igniting a heater for heating tanks for first and second propellants;
waiting until the heater reaches stable conditions;
pressurizing a first tank containing the first propellant in liquid form up to a first threshold pressure by means of the heater, and in parallel filling a first igniter tank with the first propellant in gaseous form, until reaching first ignition threshold values of temperature and of pressure;
pressurizing a second tank containing the second propellant in liquid form up to a second threshold pressure by means of the heater, and in parallel filling a second igniter tank with the second propellant in gaseous form, until reaching second ignition threshold values of temperature and of pressure; and
injecting the first and second propellants in gaseous form contained in the first and second igniter tanks into an igniter of the engine, so as to initiate combustion.

2. A method according to claim 1, wherein the first propellant is liquid oxygen and the second propellant is liquid hydrogen.

3. A method according to claim 1, wherein, after initiating combustion, the space vehicle engine is put into operation.

4. A method according to claim 1, wherein the pressurization of the first tank and the pressurization of the second tank are performed in succession.

5. A method according to claim 1, wherein the pressurization of the first tank and the pressurization of the second tank are performed simultaneously.

6. A system comprising:
a first tank of liquid propellant and a second tank of liquid propellant;
a space vehicle engine igniter fed with gaseous propellants by the first igniter tank and the second igniter tank;
a heater for pressurizing the first tank of liquid propellant and the second tank of liquid propellant; and
a controller adapted to control the heater so as to pressurize the first and second liquid propellant tanks by the heater under stable conditions;
the system being characterized in that the controller and the heater are configured:
while pressurizing the first liquid propellant tank, to feed the first propellant in gaseous form to the first igniter tank until reaching threshold ignition values of temperature and of pressure;
while pressurizing the second liquid propellant tank, to feed the second propellant in gaseous form to the second igniter tank until reaching threshold ignition values of temperature and of pressure; and
the controller being configured in such a manner as to inject the contents of the first igniter tank and of the second igniter tank into the space vehicle engine igniter so as to initiate combustion.

7. A system according to claim 6, wherein the first propellant is liquid oxygen and the second propellant is liquid hydrogen.

8. A system according to claim 6, wherein the controller is configured to control putting the space vehicle engine into operation after initiation of combustion by injecting the contents of the first igniter tank and of the second igniter tank into the space vehicle engine igniter.

9. A system according to claim 6, wherein the controller is configured to control the heater in such a manner that the first igniter tank and the second igniter tank are fed in succession or simultaneously.

10. A system according to claim 6, wherein:
the first igniter tank is connected to the igniter via a first igniter valve and to the heater via a first feed valve; and
the second igniter tank is connected to the igniter via a second igniter valve and to the heater via a second feed valve;
the controller being adapted to control the opening and closing of the first and second igniter and feed valves.

11. A space vehicle including a liquid propellant engine and a system according to claim 6.
